(19) United States
(12) Patent Application Publication
(10) Pub. No.: US 2024/0144548 A1
(43) Pub. Date: May 2, 2024

(54) Auto Shade

(71) Applicants: Shohreh Ghasemi, Marietta, GA (US); Mahmood Dashti, Istanbul (TR); Atefeh Manocherian naeini, Istanbul (TR)

(72) Inventors: Shohreh Ghasemi, Marietta, GA (US); Mahmood Dashti, Istanbul (TR); Atefeh Manocherian naeini, Istanbul (TR)

(21) Appl. No.: 17/974,651

(22) Filed: Oct. 27, 2022

(51) Int. Cl. G06T 11/00; A61C 13/00; A61C 19/10; G06T 7/11; G06T 7/13; H04N 1/60

(52) U.S. Cl. CPC G06T 11/001; A61C 13/0004; A61C 19/10; G06T 7/11; G06T 7/13; H04N 1/6008; G06T 2207/10024; G06T 2207/30036

(57) ABSTRACT

A novel form of a dental auto shade management, where a user interface and a system for use in determining shade of a patient's tooth is presented. The digital 3D representation includes color data and texture data for the tooth is obtained. A tooth shade value for at least one point on the tooth is determined and shown visually in a graphical format. Once the shade mapping is finished, the printing machine will use various tints and apply them to the surface of the either laminate or crown based on the map shade, to match surrounding teeth.

### BACKGROUND

### Field of the Invention

The present invention relates generally to color shade guides used in dentistry. The new and improved shade guide system offers a more efficient and practical approach to the shade-matching procedure using a machine-based approach which is convenient and reliable to use.

### Description of the Related Art

Dental restorations repair weakened, damaged or missing teeth. Direct placement restorations are made by applying a dental composite directly to damaged tooth structure. Indirect placement restorations, including inlays and onlays, are also often made of dental composites but are shaped outside of the oral cavity and then placed in or on the tooth structure. Restorations may also include crowns, bridges, implants, dentures and the like that comprise an artificial tooth or set of teeth which is secured in place in the oral cavity.

Preferably, dental restorations simulate as close as possible the appearance of remaining visible tooth structure in the patient's mouth so that the restoration looks as natural as possible. However, the color of teeth varies from individual to individual, and also varies somewhat from tooth to tooth in the mouth. As such, care must be undertaken to select a restorative material that has a color which is closely similar to the color of adjacent teeth.

Typically, a set of dental shade guides, each of a different color, is used to select a color for the restoration. The shade guides are held next to the teeth in order to facilitate comparison of the colors of the different guides with the color of tooth structure adjacent the restoration. Once a particular guide is chosen, indicia on the guide enable the dentist to choose restorative material with proper coloring or pigments so that the restoration, once completed and in the mouth, appears as aesthetic as practicable.

The nature and perception of color is somewhat subjective. Color may be measured by a visual technique, often called the Munsell Color System, which identifies three parameters: hue, value and chroma. Hue is measured on a numeric scale for each of the ten color families (such as red, yellow-red, yellow and the like). Value (or brightness) varies from black to white on a numeric scale and the value of a given color can be modified by the addition of a white pigment. Chroma (or saturation) is a measurement of the amount of color which is present at a given hue, and ranges on a numeric scale from 0 (which is achromatic or gray and has no color) to a fully saturated hue which is 18. The hue, chroma and value taken together define the color of an object under specified lighting conditions.

The perceived color of an object may be modified by the translucency or opacity of the object. Opacity is often measured in terms of a contrast ratio, which changes in a particular object in accordance with the thickness of the object. For more information, see, e.g., “Restorative Dental Materials”, edited by Robert G. Craig and published in 1989 by C. V. Mosby Company of St. Louis, Miss.

By looking at prior art, multiple advancements have been seen in similar regards. For instance, a US patent 2,009,0233253A1 on Dental shade guide discusses a new color shade guide for use in dentistry has two linearly-arranged sets of shade guides. One set includes only conventional ‘M’ hues, the other set includes only conventional ‘L’ and ‘R’ hues. Each of the two sets is arranged with the guides in a single line. Fasteners are attached to one of the sets of shade guides and enables the two sets to be connected together, back-to-back, enabling a practitioner to view all of the tooth shades in the system by simply rotating the attached guides. Blue and violet colored translucent sheets are included in a kit to enable a practitioner to efficiently isolate the ‘value’ component of the Munsell color system by comparing the perceived color of the tooth or teeth as viewed through the colored sheet with the perceived color of the shade guide as viewed through the same sheet.

A U.S. Pat. No. 4,207,678A on multiple dental shade guide systems provides system for increasing the accuracy in matching an artificial tooth coloring to a patient's natural teeth by providing a plurality of primary shade guides, each guide having a specific chroma percentage made from a predetermined formula. Each primary shade guide has a corresponding plurality of secondary shade guides such that each of the corresponding secondary shade guides has a decreased chroma percentage which is determined by varying the value ratio of the primmary shade guide formula. This is accomplished by mixing the primary shade guide formula in varying amounts with a gray or white modifier. In one embodiment of the invention the secondary shade guides provide a chroma range which in selected applications overlaps with the chroma range of several of the primary shade guides providing the practitioner with a more accurate match. A method for making and using the secondary shade guides is disclosed.

A US patent 2,015,0173624A1 discusses dental shade matching method and device which is a method and device for determining the correct shade for porcelain crowns, composite fillings and other dental restorations comprising generating a light spectrum in at least two distinct wavelength spectra in sequence under the control of the operator of the light source generating the light spectrum with light in the first wavelength spectrum corresponding to daylight to enable the dentist or dental professional to perform a shade match the way a patient would view their restoration outside of a dental office in a real world environment and then switching to a second wavelength spectrum corresponding to either room light or ambient light.

There are multiple solutions that have been presented in the prior art. However, these solutions are limited and restricted to their conventional systems. The current invention is focused on presenting a computer-guided system that uses machine learning and a sophisticated approach to detecting and matching the most accurate tooth color with simple clicks by the dentist. The proposed method involves minimal subjective input and provides reliable results.

None of the previous inventions and patents, taken either singly or in combination, is seen to describe the instant invention as claimed. The invention in discussion is a development of the existing way of detecting and matching tooth shades. Hence, the inventor of the present invention proposes to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The invention details the disclosure of methods and user interfaces for determining the shade of a patient's tooth or teeth and for utilizing the determined tooth shades for designing and manufacturing dental restorations.

The primary object of the invention is related to simplifying the process of conventional dental shade management approaches.

It is further the objective of the invention to provide an approach that is easy to use and requires minimal input from the user.

It is also the objective of the invention to provide output in form of graphical output which is easier to understand and implement.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the detection of each pixel in the image, wherein in this figure, a part of the picture is used to show the pixels as per preferred embodiments of the invention.

FIG. 2 shows the easier schematic of the shade guide. as per preferred embodiments of the invention.

FIG. 3 shows the Flowchart of the application, as per preferred embodiments of the invention.

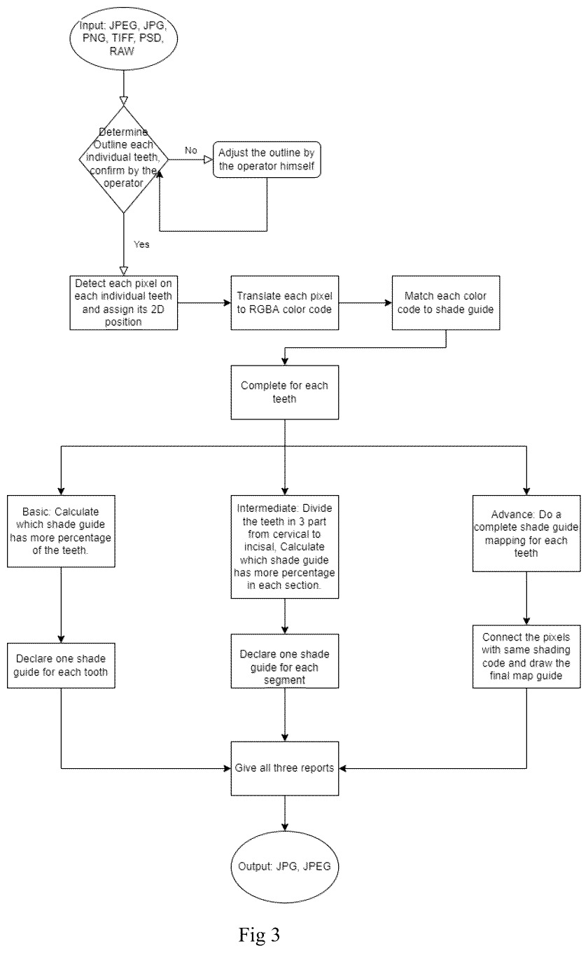

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The invention in its preferred embodiment is a novel approach toward auto shade management.

Typically the shade matching process includes the Dentist taking 5*5 mm2 block of the desired composite with a 3 mm thickness, then putting it on a black piece of paper, and then taking a picture with their camera or smartphone in the same lighting situation for the calibration. Later the dentist will choose the composite brand, series, and shade from the application menu so the calibration starts (Table 01).

| Composite brand | Series | Shade |
|---|---|---|
| Ultradent | Vit-el-esense | A1-A2-A3-B1-B2-B3- |
| | Amaris | BW-XBW |
| Ivoclar | IPS | A1-A2-A3-B1-B2-B3- |
| | Tetric-N-Ceram | BW-XBW |
| Cosmodent | | A1-A2-A3-B1-B2-B3- |
| | | BW-XBW |
| FGM | Opalis | A1-A2-A3-B1-B2-B3- |
| | | BW-XBW |
| GC | G-aenial | A1-A2-A3-B1-B2-B3- |
| | Gradia | BW-XBW |

The dentist will choose the composite based on what brand they use in their offices. Then the dentist will take a picture of the teeth in the same lighting condition, but if the dentist is using the software as a plugin for the oral scanner, the lighting is fixed with the device setting, so there is no need for calibration.

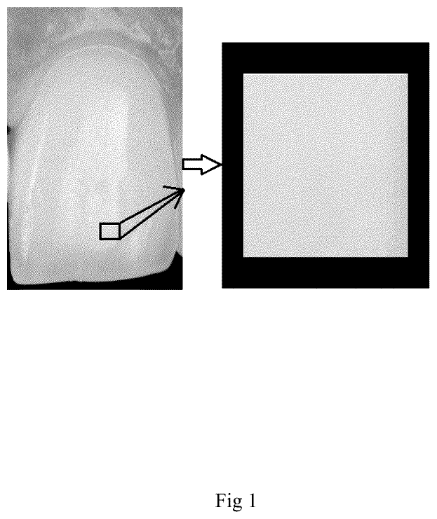

The current software as per its preferred embodiments detects each pixel in the final image, and provides a more accurate picture, with higher resolution as shown in FIG. 01. The oral scanners can either convert the final 3D images to 2D images or record the normal 2D images as the dentist scans the teeth.

As per its preferred embodiments, the dentist takes the picture from the desired teeth, since the accuracy will decrease with a bigger field of view, by focusing on single teeth, more pixels will be assigned to each tooth.

As it is shown in FIG. 01, the teeth will be bread down to their pixels, and then the software will detect the color code for each pixel, based on the desired color system (such as RGBA). The table 2 shows the Shade guide created by the software for the desired tooth based on the chosen color-coding system, wherein, in this example, RGBA, and HEX are disclosed as per preferred embodiments of the invention.

| PIXEL CODE | RGBA | HEX |
|---|---|---|
| 128*295 | rgba(222, 217, 220, 255) | #ded9dc |
| 150*295 | rgba(212, 210, 213, 255) | #d4d2d5 |
| 128*312 | rgba(217, 211, 215, 255) | #d9d3d7 |
| 150*312 | rgba(202, 199, 200, 255) | #cac7c8 |

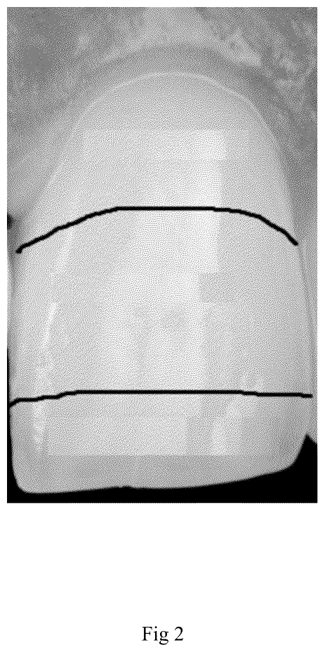

As per its further embodiments, each color code, either RGBA or HEX, will be converted to dental shade guides such as Vita Classic, or Vita 3D master. Each range of RGBA or HEX color codes will be assigned to a single dental shade guide as shown in FIG. 2.

As per its further embodiments, the software will aim to cover every practice, so will include all the available shade guides to the database, so the dentist or ceramist can choose which shade guide they want to use.

As per further embodiments of the invention, the ceramic powder-specific shade guide which has been created by us with different thicknesses and combinations.

| PRO USERS | PRO VIP USERS |
|---|---|
| VITA CLASSIC | Ceramic powder shade guide with |
| | deferent brands |
| 3D VITA | |
| NORITAKE | |
| COLTEN | |
| IVOCLAR TETRIC | |

As per further embodiments, the shade mapping is finished, and the designs are sent to the Tinter machine this machine is a printing machine that will use various tints and apply them to the surface of either laminate or crown based on the map shade, to match surrounding teeth.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1: An auto shade management wherein:
As per claim 1, the input is provided in form of a picture format;
As per claim 1, the software will determine the outline of each individual teeth;
As per claim 1, the software will prompt the user to adjust the outline of the operator if the outcome needs edit;
As per claim 1, the software will detect each pixel on each individual tooth and will assign 2D position;
As per claim 1, the software will translate each pixel to RGBA color code;
As per claim 1, the software will match each color code to the shade guide;
As per claim 1, the basic method will involve calculating which shade guide has more percentage of teeth;
As per claim 1, the basic method will declare one shade guide for each totth;
As per claim 1, the intermediate method will involve diving the teeth in 3 parts and calculating which shade guide has more percentage in each section,
As per claim 1, the intermediate method will declare one shade guide for each segment;
As per claim 1, the advanced method will involve shade guide mapping for each tooth;
As per claim 1, the advanced method will connect the pixels with the same shading code and draw the final map guide; and,
As per claim 1, the report from each level will be accumulated and displayed to the user.
